(19) United States
(12) Patent Application Publication
(10) Pub. No.: US 2007/0229030 A1
(43) Pub. Date: Oct. 4, 2007

(54) Battery charging circuit and method for reducing heat generated by the circuit during inactive periods

(76) Inventors: Deng Peng Chen, Denver, CO (US); Wee Sin Tan, Denver, CO (US)

Correspondence Address: Kathy Manke;Avago Technologies Limited, 4380 Ziegler Road, Fort Collins, CO, 80525, US

(21) Appl. No.: 11/395,571

(22) Filed: Mar. 31, 2006

(51) Int. Cl. H02J 7/00

(52) U.S. Cl. 320/128

(57) ABSTRACT

A transformer-based battery charging circuit and method for reducing heat generated by the circuit during inactive periods uses a light emitting device, which is electrically connected to the secondary winding of a transformer, and a light-dependent resistor, which is electrically connected to the primary winding of the transformer, to decrease the current conducted through the primary winding of the transformer during the inactive periods.

### BACKGROUND OF THE INVENTION

The use of mobile electronic devices has sharply increased in recent years due to a number of popular mobile electronic devices in the consumer market. Some of these popular mobile electronic devices include cellular phones, personal digital assistants (PDAs), digital still and video cameras, handheld email devices and MP3 players. One common trait of these mobile electronic devices is that each of these devices uses a battery, and thus, requires a battery charging circuit to charge the battery using a power source, e.g., an AC power grid via an electric wall socket. Since most battery charging circuits cannot be used for different mobile electronic devices, it is common for a user to have several battery charging circuits to charge the batteries in the different mobile electronic devices. It is also common for these battery charging circuits to remain plugged in the electric wall sockets during inactive periods when the batteries are removed from the battery charging circuits.

Many battery charging circuits are based on transformers. A typical transformer-based battery charging circuit includes in part a plug, a transformer and a bridge rectifier. The plug is electrically connected to the primary winding of the transformer on a first current path. The bridge rectifier is connected to the secondary winding of the transformer on a second current path. When the plug is plugged into an electric wall socket and a battery is electrically connected to the second current path, the AC signal from the electric wall socket is conducted through the first current path through the primary winding of the transformer, which induces current to be conducted through the secondary winding of the transformer via magnetic coupling. Thus, current is conducted through the second current path to which the battery is connected. The bridge rectifier converts the AC signal produced at the secondary winding of the transformer to direct current (DC) signal, which is applied to the battery.

A concern with these conventional transformer-based battery charging circuits is that, even during inactive periods when there is no load, i.e., no battery connected to the circuits, a significant amount of current is still conducted through the primary winding of the transformer. This is due to the fact that transformers are not ideal. As a result, the transformer generates heat during the entire time when the battery charging circuit is not being used, mostly due to the resistance of the primary winding of the transformer. The constant heat generated by the transformer during the inactive periods can shorten the lifetime of that battery charging circuit.

In view of the above concern, what is needed is a transformer-based battery charging circuit and method for reducing heat generated by the circuit during inactive periods.

### SUMMARY OF THE INVENTION

A transformer-based battery charging circuit and method for reducing heat generated by the circuit during inactive periods uses a light emitting device, which is electrically connected to the secondary winding of a transformer, and a light-dependent resistor, which is electrically connected to the primary winding of the transformer, to decrease the current conducted through the primary winding of the transformer during the inactive periods. The decrease in current conducted through the primary winding of the transformer during the inactive periods reduces the amount of heat generated by the transformer. This reduction of heat during the inactive periods can significantly increase the lifetime of the battery charging circuit.

A battery charging circuit in accordance with an embodiment of the invention comprises a transformer having a primary winding and a secondary winding, a light emitting device electrically connected to the secondary winding of the transformer and a light-dependent resistor having a variable resistance electrically connected to the primary winding of the transformer. The light emitting device is configured to generate light in response to current conducted through the secondary winding of the transformer. The light-dependent resistor is positioned to receive the light generated by the light emitting device to change the variable resistance of the light-dependent resistor so that current conducted through the primary winding of the transformer is decreased in response to the light to reduce the amount of heat generated by the primary winding of the transformer.

A battery charging circuit in accordance with another embodiment of the invention comprises a transformer having a primary winding and a secondary winding, a first current path through the primary winding of the transformer, a second current path through the secondary winding of the transformer, a light emitting device electrically connected to the secondary winding of the transformer on the second current path and a light-dependent resistor having a variable resistance electrically connected to the primary winding of the transformer on the first current path. The first current path includes input terminals to be connected to a power source. The second current path includes output terminals to be connected to a battery to be charged. The light emitting device is configured to generate light in response to current conducted through the secondary winding of the transformer. The light-dependent resistor is positioned to receive the light generated by the light emitting device to change the variable resistance of the light-dependent resistor so that current through the primary winding of the transformer is decreased to reduce the amount of heat generated by the primary winding during inactive periods when the battery is not connected to the output terminals.

A method for reducing heat generated in a transformer-based battery charging circuit during inactive periods in accordance with an embodiment of the invention comprises removing a battery from the battery charging circuit, changing the intensity of light generated by a light emitting device of the battery charging circuit in response to the removing of the battery, and changing the resistance of a light-dependent resistor of the battery charging circuit in response to the changing of the intensity of light, including decreasing current conducted through a transformer of the battery charging circuit to reduce the amount of heat generated by the transformer.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a circuit diagram of a transformer-based battery charging circuit in accordance with an embodiment of the invention.

FIG. 2A is a partial circuit diagram of the battery charging circuit of FIG. 1, illustrating a decrease in the resistance of a light-dependent resistor of the circuit in response to an increase in the intensity of light generated by a light emitting device of the circuit in accordance with an embodiment of the invention.

FIG. 2B is a partial circuit diagram of the battery charging circuit of FIG. 1, illustrating an increase in the resistance of the light-dependent resistor in response to a decrease in the intensity of light generated by a light emitting device of the circuit in accordance with an embodiment of the invention.

FIG. 3 is a process flow diagram of a method for reducing heat generated by a transformer-based battery charging circuit during inactive periods in accordance an embodiment of the invention.

### DETAILED DESCRIPTION

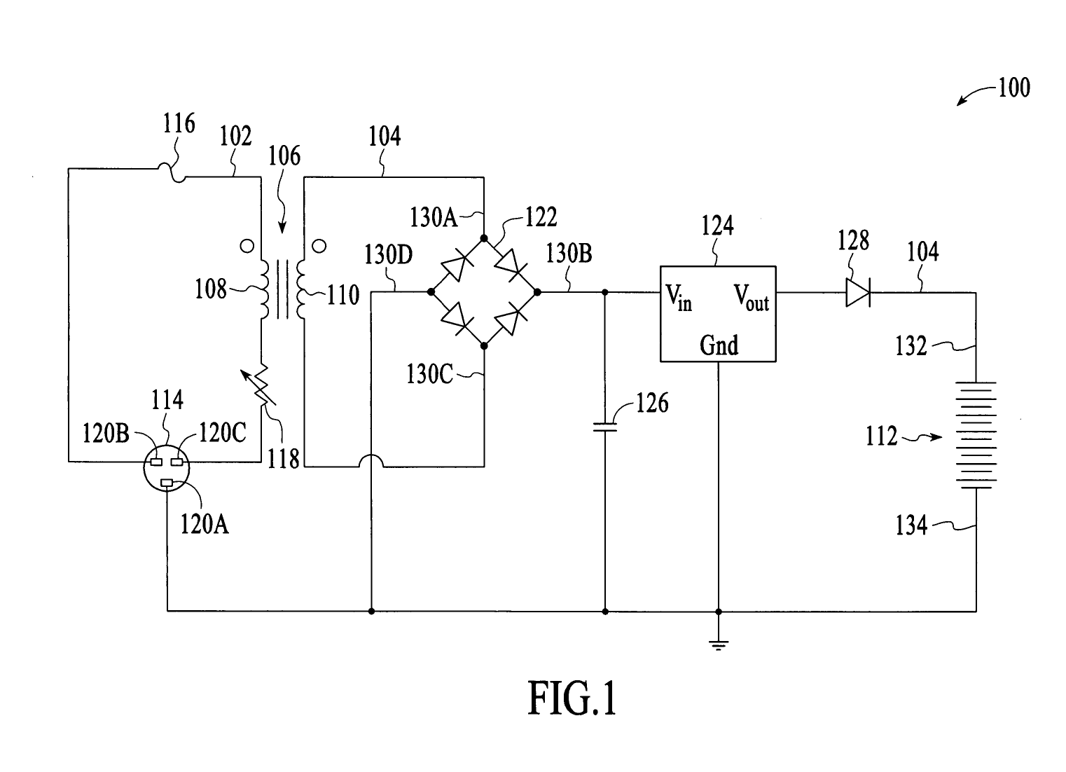

With reference to FIG. 1, a transformer-based battery charging circuit 100 in accordance with an embodiment of the invention is described. As described in more detail below, the battery charging circuit 100 is designed such that during inactive periods, i.e., when the circuit is not charging a battery, the amount of heat generated by the circuit is significantly reduced. Thus, the battery charging circuit 100 does not suffer from shorten lifetime due to the generated heat during the inactive periods as conventional transformer-based battery charging circuits.

As shown in FIG. 1, the battery charging circuit 100 includes an input current path 102 and an output current path 104, which are electrically connected to a transformer 106. The input current path 102 is electrically connected to a primary winding 108 of the transformer 106, while the output current path 104 is electrically connected to a secondary winding 110 of the transformer. The input current path 102 is used to conduct an input alternating current (AC) signal from an AC power source, e.g., an electric wall socket connected to an AC power grid. Since the primary winding 108 of the transformer 106 is connected to the input current path 102, the input AC signal is conducted through the primary winding of the transformer. Through magnetic coupling, the transformer 106 operates to transfer the electrical energy from the primary winding 108 to the secondary winding 110 to produces an output AC signal on the secondary winding. The output current path 104 is used to conduct the output AC signal, which is converted into direct current (DC) signal to charge a battery 112 electrically connected to the output current path, as described below.

As shown in FIG. 1, the battery charging circuit 100 further includes a plug 114, a fuse 116 and a light-dependent resistor 118. The plug 114, the fuse 116 and the light-dependent resistor 118 are connected in series with the primary winding 108 of the transformer 106 on the input current path 102. The plug 114 is a three-prong plug configured to be inserted into an electric wall socket, which is connected to an AC power grid. Thus, the electric wall socket is an AC power source for the battery charging circuit 100 when the plug is inserted into the electric wall socket. The plug 114 includes a ground prong 120A, a hot prong 120B and a neutral prong 120C. The ground prong 120A of the plug 114 is electrically connected to ground. The hot and neutral prongs 120B and 120C of the plug 114 are electrically connected to the input current path 102. The fuse 116 is connected on the input current path 102 between the hot prong 120B of the plug 114 and the primary winding 108 of the transformer 106 to provide protection for the battery charging circuit 100 from a sudden increase of current on the input current path.

The light-dependent resistor 118 is connected on the input current path 102 between the neutral prong 120C of the plug 114 and the primary winding 108 of the transformer 106 to provide a variable resistance on the input current path. The light-dependent resistor 118 is an electrical component whose variable resistance depends on the intensity of light incident on the resistor. Such an electrical component is also known as a photoresistor or a photoconductor. When the intensity of the incident light increases, the variable resistance of the light-dependent resistor 118 decreases accordingly. Conversely, when the intensity of the incident light decreases, the variable resistance of the light-dependent resistor 118 increases accordingly. The spectral response range of the light-dependent resistor 118 may include infrared (IR), visible light and/or ultraviolet (UV) frequencies. Depending on the type, the light-dependent resistor 118 provides a fixed “dark” resistance, i.e., the resistance when no light is incident on the resistor. In an embodiment, the light-dependent resistor 118 is a cadmium sulfide (CdS) photocell. However, in other embodiments, the light-dependent resistor 118 can be any type of a light-dependent resistor.

The battery charging circuit 100 further includes a bridge rectifier 122, a voltage regulator 124, a capacitor 126, a light emitting device 128 and positive and negative output terminals 132 and 134. The bridge rectifier 122 is electrically connected to the secondary winding 110 of the transformer 106 on the output current path 104. The bridge rectifier 122 operates to convert the output AC signal on the secondary winding 110 of the transformer 106 into a DC signal. The bridge rectifier 122 includes four diodes that are arranged as a bridge circuit. The bridge rectifier 120 includes four terminals 130A, 130B, 130C and 130D. The terminals 130A and 130C of the bridge rectifier 120 are electrically connected to both ends of the secondary winding 110 of the transformer 106 to receive the AC signal on the secondary winding. The terminal 130C of the bridge rectifier 122 is electrically connected to ground. The terminal 130B of the bridge rectifier 122 is electrically connected to the voltage regulator 124 and the capacitor 126 to output a DC signal. The capacitor 126 is electrically connected between the terminal 130B of the bridge rectifier 122 and ground. The capacitor 126 operates to filter the output DC signal from the bridge rectifier 122 to smooth or flatten the output DC signal. The voltage regulator 124 includes an input, an output and a ground terminal. The input of the voltage regulator 124 is electrically connected to the capacitor 126 and the terminal 130B of the bridge rectifier 122, while the output of the voltage regulator 124 is electrically connected to the light emitting device 128. The ground terminal of the voltage regulator 124 is electrically connected to ground. The voltage regulator 124 operates to receive the filtered DC signal and produce a more stable output signal with respect to voltage. The voltage regulator 124 ensures that a proper DC signal is applied to the battery 112 being charged by the battery charging circuit 100.

The light emitting device 128 is connected between the voltage regulator 124 and the positive output terminal 132 on the output current path 104. The battery 112 to be charged can be electrically connected to the battery charging circuit 100 by being connected to the positive output terminal 132 and the negative output terminal 134, which is electrically connected to ground. In the illustrated embodiment, the light emitting device 128 is a light emitting diode, which functions both as a light emitter and a reverse current blocking device. Thus, the light emitting device 128 will be referred to herein as a light emitting diode. However, in other embodiments, the light emitting device 128 can be any light emitter, such as a laser. The light emitting diode 128 generates light when current is conducted through the diode, which occurs when there is load on the battery charging circuit 100, i.e., the battery 112 to be charged is connected to the circuit, and the circuit is connected to a power source. However, the light emitting diode 128 generates little or no light when minimal amount of current is conducted through the diode, which occurs when there is no load on the battery charging circuit 100, i.e., no battery is connected to the circuit, and the circuit is still connected to the power source. The light emitting diode 128 can be configured to generate a peak wavelength in IR, visible light or UV spectral range. The light emitting diode 128 and the light-dependent resistor 118 are positioned in close proximity to each other so that much of the light generated by the light emitting diode is incident on the light-dependent resistor.

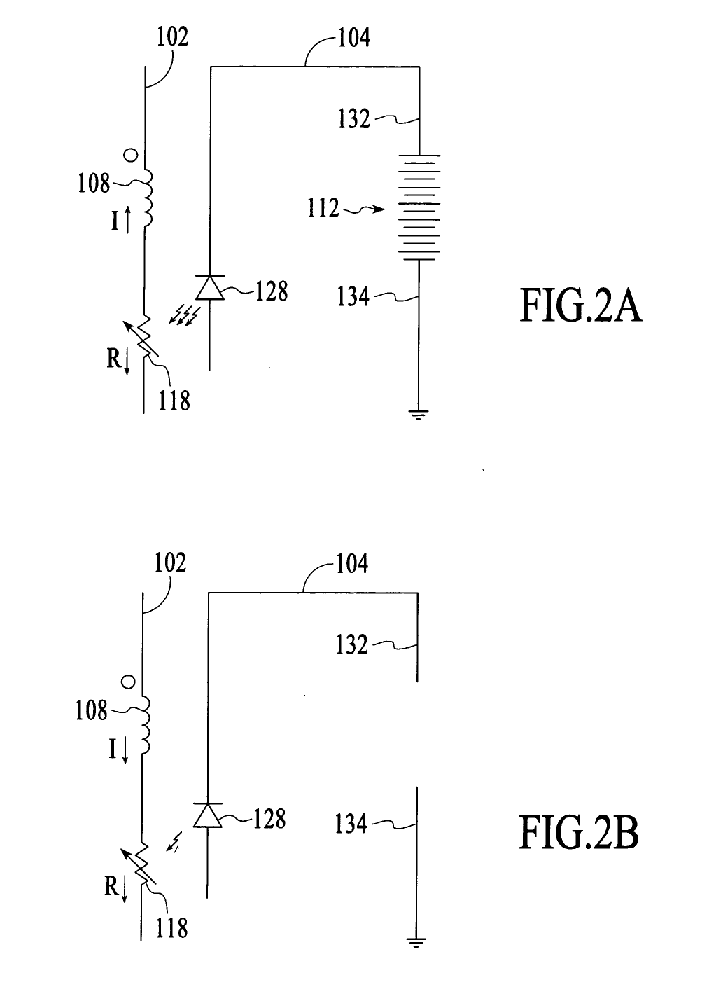

The light generated by the light emitting diode 128 on the output current path 104 is used to control the variable resistance of the light-dependent resistor 118 on the input current path 102. When the battery 112 to be charged is connected to the battery charging circuit 100 and the circuit is plugged into an electric wall socket, the current through the light emitting diode 128 is increased. In response, as illustrated in FIG. 2A, the light emitting diode 128 generates light of higher intensity, which is incident on the light-dependent resistor 118. Consequently, the variable resistance of the light-dependent resistor 118 is decreased, and thus, the current on the input current path 102 through the primary winding 108 of the transformer 106 is increased. However, when no battery is connected to the battery charging circuit 100 and the circuit is still plugged into the electric wall socket, the current through the light emitting diode 128 is significantly decreased. In response, as illustrated in FIG. 2B, the light emitting diode 128 generates no light or light of lower intensity, which is incident on the light-dependent resistor 118. Consequently, the variable resistance of the light-dependent resistor 118 is significantly increased, and thus, the current on the input current path 102 through the primary winding 108 of the transformer 106 is decreased, which reduces the amount of heat generated by the primary winding of the transformer. Therefore, the light emitting diode 128 and the light-dependent resistor 118 function as an automatic feedback loop to detect when a battery to be charged is connected to the battery charging circuit 100 and to selectively reduce the current conducted through the primary winding 108 of the transformer 106 when no battery is connected to the circuit.

The overall operation of the battery charging circuit 100 is now described with reference to FIG. 1. In order to charge the battery 112 using the battery charging circuit 100, the battery is electrically connected to the output terminals 132 and 134 and the plug 114 is inserted into an electrical wall socket.

Since the electric wall socket is connected to an AC power grid, the electric wall socket serves as an AC power source for the battery charging circuit 100. As a result, an input AC signal is conducted through the input current path 102, and thus, and thus, through the primary winding 108 of the transformer 106. The AC signal through the primary winding 108 of the transformer 106 induces an output AC signal to be conducted through the secondary winding 110 of the transformer via magnetic coupling. The magnetically induced AC signal is then converted into a DC signal by the bridge rectifier 122. The DC signal from the bridge rectifier 122 is then filtered by the capacitor 126 to smooth the signal. The filtered DC signal is then regulated by the voltage regulator 124, which produces a more stable output DC signal with respect to voltage. The output DC signal is transmitted to the battery 112 through the light emitting diode 128, which generates high intensity light in response to the output DC signal. Consequently, the amount of light incident on the light-dependent resistor 118 is increased, which decreases the variable resistance of the light-dependent resistor. Since the variable resistance of the light-dependent resistor 118 is decreased, the current on the input current path 102 is not significantly impeded by the light-dependent resistor, and the battery charging circuit 100 functions similar to comparable conventional battery charging circuits.

However, when the battery 112 is removed from the battery charging circuit 100, the current through the light emitting diode 128 is significantly decreased. Thus, the light emitting diode 128 generates light of very low intensity, if any. Consequently, the amount of light incident on the light-dependent resistor 118 is decreased, which increases the variable resistance of the light-dependent resistor. The high resistance of the light-dependent resistor 118 decreases the current conducted through the input current path 102, and thus, the current conducted through the primary winding 108 of the transformer 106. The decreased current through the primary winding 108 of the transformer 106 results in a reduced amounted of heat generated by the primary winding. Thus, the heat generated by the battery charging circuit 100 during inactive periods is significantly decreased.

Simulations were carried out for a battery charging circuit in accordance with an embodiment of the invention with a light-dependent resistor having a “dark” resistance of 5 M ohms and 500 k ohms. When no automatic feedback loop was used, the power consumption of the battery charging circuit during inactive periods was 210 mW. When the automatic feedback loop was used, the power consumption of the battery charging circuit during inactive periods was 9.8 mW for the light-dependent resistor having a “dark” resistance of 5 M ohms and 95 mW for the light-dependent resistor having a “dark” resistance of 500 k ohms. These results show that the use of automatic feedback loop in accordance with an embodiment of the invention can reduce heat generation of a transformer-based battery charging circuit during inactive periods. Furthermore, higher the “dark” resistance of the light-dependent resistor used in a transformer-based battery charging circuit, greater heat reduction can be expected.

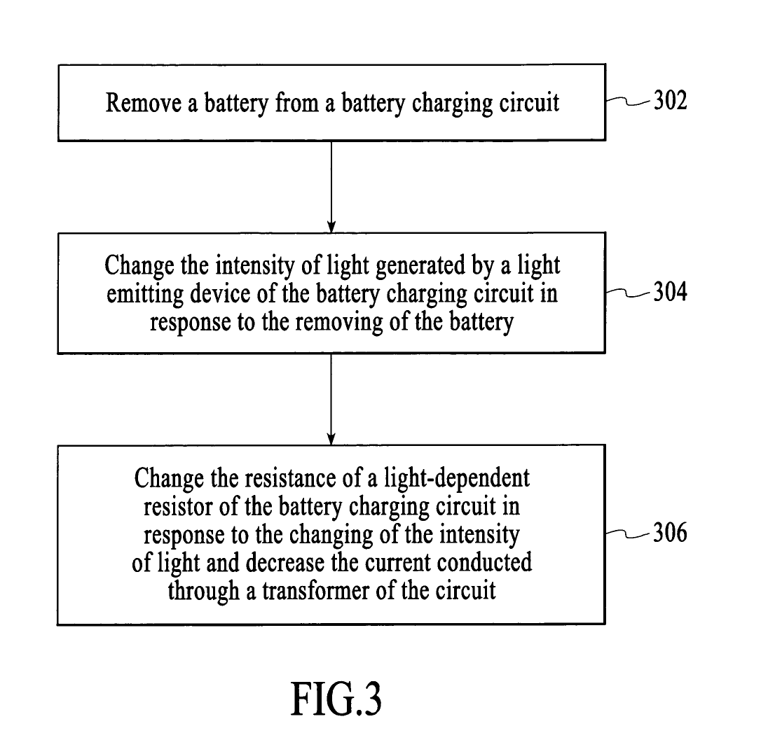

A method for reducing heat generated in a transformer-based battery charging circuit during inactive periods in accordance with an embodiment of the invention is described with reference to FIG. 3. At block 302, a battery is removed from the battery charging circuit. In other words, the battery is no longer electrically connected to the battery charging circuit. Next, at block 304, the intensity of light generated by a light emitting device of the battery charging circuit is changed in response to the removing of the battery. Next, at block 306, the resistance of a light-dependent resistor of the battery charging circuit is changed in response to the changing of the intensity of light. In addition, at block s 306, current conducted through a transformer of the battery charging circuit is decreased to reduce the amount of heat generated by the transformer of the battery charging circuit.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A battery charging circuit comprising:
a transformer having a primary winding and a secondary winding;
a light emitting device electrically connected to said secondary winding of said transformer, said light emitting device being configured to generate light in response to current conducted through said secondary winding of said transformer; and
a light-dependent resistor having a variable resistance electrically connected to said primary winding of said transformer, said light-dependent resistor being positioned to receive said light generated by said light emitting device to change said variable resistance of said light-dependent resistor so that current conducted through said primary winding of said transformer is decreased in response to said light to reduce the amount of heat generated by said primary winding of said transformer.

2. The circuit of claim 1 wherein said light-dependent resistor includes a photocell.

3. The circuit of claim 2 wherein said photocell is a cadmium sulfide photocell.

4. The circuit of claim 1 wherein said light emitting device includes a light emitting diode.

5. The circuit of claim 1 further comprising a bridge rectifier and a voltage regulator, said bridge rectifier being electrically connected to said secondary winding of said transformer to convert said current through said secondary winding from alternating current to direct current, said voltage regulator being electrically connected to said bridge rectifier to regulate a charging voltage.

6. The circuit of claim 5 wherein said light emitting device is positioned between an output of said voltage regulator and a positive output terminal, said positive output terminal being used to electrically connect said battery to said circuit.

7. The circuit of claim 5 further comprising a capacitor connected to an output of said bride rectifier and electrical ground.

8. The circuit of claim 1 wherein said light-dependent resistor is positioned between said primary winding of said transformer and a neutral input terminal, said neutral input terminal being used to electrically connect said circuit to a power source.

9. A battery charging circuit comprising:
a transformer having a primary winding and a secondary winding;
a first current path through said primary winding of said transformer, said first current path including input terminals to be connected to a power source;
a second current path through said secondary winding of said transformer, said second current path including output terminals to be connected to a battery to be charged;
a light emitting device electrically connected to said secondary winding of said transformer on said second current path, said light emitting device being configured to generate light in response to current conducted through said secondary winding of said transformer; and
a light-dependent resistor having a variable resistance electrically connected to said primary winding of said transformer on said first current path, said light-dependent resistor being positioned to receive said light generated by said light emitting device to change said variable resistance of said light-dependent resistor so that current through said primary winding of said transformer is decreased to reduce the amount of heat generated by said primary winding during inactive periods when said battery is not connected to said output terminals.

10. The circuit of claim 9 wherein said light-dependent resistor includes a photocell.

11. The circuit of claim 10 wherein said photocell is a cadmium sulfide photocell.

12. The circuit of claim 9 wherein said light emitting device includes a light emitting diode.

13. The circuit of claim 9 further comprising a bridge rectifier and a voltage regulator, said bridge rectifier being electrically connected to said secondary winding of said transformer to convert said current through said secondary winding of said transformer from alternating current to direct current, said voltage regulator being electrically connected to said bridge rectifier to regulate a charging voltage.

14. The circuit of claim 13 wherein said light emitting device is positioned between an output of said voltage regulator and a positive output terminal of said output terminals.

15. The circuit of claim 9 wherein said light-dependent resistor is positioned between said primary winding of said transformer and a neutral input terminal of said input terminals.

16. A method for reducing heat generated in a transformer-based battery charging circuit during inactive periods, said method comprising;
removing a battery from said battery charging circuit;
changing the intensity of light generated by a light emitting device of said battery charging circuit in response to said removing of said battery; and
changing the resistance of a light-dependent resistor of said battery charging circuit in response to said changing of said intensity of light, including decreasing current conducted through a transformer of said battery charging circuit to reduce the amount of heat generated by said transformer of said battery charging circuit.

17. The method of claim 16 wherein said light emitting device is electrically connected to a secondary winding of said transformer of said battery charging circuit and wherein said light-dependent resistor is electrically connected to a primary winding of said transformer.

18. The method of claim 16 wherein said light-dependent resistor includes a photocell.

19. The method of claim 16 wherein said light emitting device includes a light emitting diode.

20. The method of claim 16 wherein said changing said intensity of light includes decreasing said intensity of light, and wherein said changing said resistance of said light-dependent resistor includes increasing said resistance of said light-dependent resistor.
